(19) United States
(12) Patent Application Publication
(10) Pub. No.: US 2014/0150136 A1
(43) Pub. Date: May 29, 2014

(54) COMPOSITIONS AND METHODS FOR REDUCING FUGITIVE DUST PARTICLES

(71) Applicant: CYTEC TECHNOLOGY CORP., Wilmington, DE (US)

(72) Inventor: Sathanjheri RAVISHANKAR, Shelton, CT (US)

(73) Assignee: CYTEC TECHNOLOGY CORP., Wilmington, DE (US)

(21) Appl. No.: 14/086,343

(22) Filed: Nov. 21, 2013

Related U.S. Application Data
(60) Provisional application No. 61/730,288, filed on Nov. 27, 2012.

(51) Int. Cl. C05G 3/00

(52) U.S. Cl. CPC C05G 3/0088
USPC 800/298; 71/62; 252/88.1; 428/454

(57) ABSTRACT

Coating compositions of an aqueous mineral slurry having a dust suppressing amount of an absorbent and/or non-absorbent silicate mineral, and methods of using same for coating dust producing substrates, such as single or multi-nutrient fertilizers, with a substantially continuous outer or top layer for reducing or eliminating dissemination of fugitive dust particles, are provided herein.

### CROSS-REFERENCE To RELATED APPLICATIONS

This application claims the benefit of priority from U.S. Provisional Application No. 61/730,288 filed Nov. 27, 2012 the content of which is incorporated herein by reference in its entirety.

### BACKGROUND OF THE INVENTION

1. Field of the Invention

The present invention relates to compositions and methods for reducing or eliminating fugitive dust particles from dust producing substrates. More particularly, the present invention relates to aqueous mineral slurries which are useful as coatings to suppress the emission of dust particles during the storage, shipping, and spreading of solid particulate substrates such as fertilizer. The invention further relates to improvements in such solid particulate fertilizers and processes for making same.

2. Description of the Related Art

Dust dissemination poses safety, health, and environmental problems in many commercial environments. For instance, in many industries, the transportation handling and storage of bulk solids is common as in industries such as mining, mineral processing, agricultural, power, steel, paper, etc. One major problem associated with bulk solids is dust generation and the control of fugitive dust emissions.

Industrial sources of fugitive dust include open operations, leaks and spills, storage, disposal, transit or poor housekeeping of sundry finely divided solid particulates. The iron and steel industries are replete with examples of the above enumerated categories. Erosion of exposed masses of particulate matter such as coal or mine mill tailings, exposed surfaces of dirt or gravel roads, piles of dirt, and excavated overburden, due to wind, traffic, etc. causes both air pollution and economic waste. Detrimental effects on health and cleanliness result where these fine particles are carried aloft.

Inorganic fertilizers such as ammonium phosphates, ammonium nitrates, potassium nitrates, potassium chlorides, potassium sulfates, urea, and the like, are all well known in the art, as are sulphur-containing fertilizers utilizing elemental sulphur and/or sulphate (e.g., calcium sulfate, magnesium sulfate, ammonium sulfate, etc.). Methods of manufacturing these inorganic fertilizers, as well as methods of processing the fertilizer elements into particles via prilling and granulation techniques are also well known. Such fertilizers often exhibit an undesirable level of dust formation creating an increasingly growing concern about atmospheric pollution and its possible ecological and toxicological effects.

Sulphur-containing fertilizers are particularly prone to dusting since sulphur is a soft element (Moh's hardness of 2.0) and is typically exposed on the surface of the particle (e.g., either as a discrete platelet embedded within the fertilizer portion, or is situated as an outer coating or shell covering the fertilizer portion). Such fertilizers wherein elemental sulphur is incorporated into or onto the fertilizer can be of particular concern given the generation of potentially explosive sulphur dust. The dust particles generated are owing to many reasons such as : 1) inefficient removal of fines during fertilizer manufacture, 2) poor granular strength due to internal stress (thereby causing fracture of the particle and eventually leading to dust), 3) abrasion of fine surface crystals, 4) poorly adherent anticaking additives, 5) environmental variations during manufacture, storing, and handling, 6) continued chemical reaction and moisture migration, 7) breakage from the handling and transportation, and 8) the end application methods of the fertilizer granules to the soil.

While it is preferable to produce non-dusty fertilizer particles, it often is necessary to resort to special anti-dust treatments due to the difficulty in manufacturing useable particulate fertilizers that do not emit dust. While some prior art has focused primarily on the surface treatment of fertilizer particulates with petroleum oils and waxes (e.g., U.S. Pat. No. 6,355,083), there are disadvantages associated with such methods. Oils tend to volatize and/or soak into the fertilizer with time and lose their effectiveness, while waxes are difficult to handle and often require special heated application equipment. Other proposed treatment methods, as taught in U.S. Pat. No. 5,360,465, involve application of an aqueous lignosulfonate solution, other liquid fertilizers, or water to the fertilizer particles. While liquid treatment compositions, such as these, may reduce the fertilizer dust levels, the liquid compositions coated on the fertilizer particles tend to promote caking of the granular fertilizer particles.

The use of clay in fertilizer compositions has also been previously reported in U.S. Patent No. T 940,014; U.S. Pat. Nos. 2,498,480; 3,041,159; 3,062,637; 3,509,066; 4,032,319; 4,133,669; 4,318,732; 4,617,048; 4,808,206; 4,954,155; 5,176,734; 5,439,497; 5,749,936; 6,749,659; and 8,017,158. While these teachings are mostly concerned with absorptive clays and are perhaps useful to a degree with certain substrates, improvements in the field of dust suppressant compositions and methods for using same are desirable as conventional dust controlling agents have not provided significant reduction in the dissemination of dust needed to satisfy end-users.

Accordingly, environmentally friendly and cost effective coating compositions that substantially reduce or eliminate dissemination of dust from a dust producing substrate, such as a solid particulate fertilizer, during long term storage and/or handling/shipping conditions, and that can be applied by conventional coating methods and with conventional equipment without altering or interfering with the end-purpose of the substrate would be a useful advance in the art and could find rapid acceptance in any industry where dissemination of fugitive dust particles is problematic.

### SUMMARY OF THE INVENTION

The forgoing and additional objects are attained in accordance with the principles of the invention described herein, which provides, in one aspect, coating compositions in the form of a substantially continuous outer or top layer for reducing or eliminating dissemination of fugitive dust particles into the atmosphere from a dust producing substrate, wherein the coating compositions include an aqueous mineral slurry having a dust suppressing amount of a non- or low moisture absorbent silicate mineral having inter-locking chains of silicate tetrahedra.

In another aspect, the invention provides a dust producing substrate having a substantially continuous outer or top layer comprised of a dust suppressing amount of a coating composition as described herein.

In another aspect, the invention provides methods of coating a dust producing substrate by contacting an aqueous mineral slurry composition as described herein with the dust producing substrate to form a substantially continuous outer layer, and drying the coated substrate for a sufficient time and/or at a sufficient temperature to remove substantially all of the moisture from the coated substrate, thereby coating the substrate with a substantially continuous outer layer.

In yet another aspect, the invention provides methods for reducing or eliminating dissemination of fugitive dust particles into the atmosphere from a dust producing substrate by coating the substrate with a dust suppressing amount of an aqueous mineral slurry composition as described herein, e.g., according to the coating methods described herein.

The invention also provides for a number of improvements to various fertilizer compositions and methods of preparing various fertilizers.

These and other objects, features and advantages of this invention will become apparent from the following detailed description of the various aspects of the invention taken in conjunction with the accompanying Examples.

### DETAILED DESCRIPTION OF CERTAIN EMBODIMENTS OF THE INVENTION

As summarized above, the present invention pertains to the discovery of improved compositions for reducing and/or eliminating (i.e., controlling) the dissemination of dust particles from a variety of substrates that are prone to dusting due to various reasons. As described more fully below, the inventors have surprisingly discovered that aqueous mineral slurries as described in detail herein prove useful as substantially continuous coating compositions for solid particulate substrates, such as fertilizer, and provide superior benefits in terms of controlling dust released from such substrates during storage, shipping, and handling/spreading over longer periods of time. Additionally, the use of such compositions and methods described herein do not diminish or upset the intended purpose of the substrate, e.g., such as the delivery of the macronutrient or micronutrient value, or the time-dependent release of such nutrients when applied to the soil, where the substrate is a fertilizer product. The coating compositions according to the invention are also environmentally friendly, safe for handling by humans, and cost efficient. The compositions are also particularly easy to apply and can be applied by conventional coating methods and equipment.

In one aspect, the invention provides coating compositions in the form of a substantially continuous outer or top layer for reducing or eliminating dust emission from a dust producing substrate, which includes an aqueous mineral slurry having a dust suppressing amount of a non-absorbent silicate mineral having interlocking chains of silicate tetrahedra. As used herein the phrase “dust suppressing amount” refers to the amount of silicate mineral in the aqueous mineral slurry according to the invention required to effectively coat the dust producing substrate in a substantially continuous outer layer, thereby reducing and/or eliminating the emission of dust emitted from the substrate over a period of time as compared to the same substrate not coated with a coating composition according to the invention. As used herein, the phrase “substantially coated” or “substantially continuous outer or top layer” shall mean that less than about 50 percent (e.g. less than about 45 percent, or less than about 25%, or 20%, or 15%, or 10%, or 5%, or 1%, or 0.5%), of the surface area of a substrate is exposed (i.e., not covered with a desired coating composition as described herein). Those skilled in the art will appreciate that more or less slurry may be advantageously applied depending on the substrate and its intended use or purpose. Such a determination can be readily made by those of skill in the art using only routine experimentation.

As used herein, the phrase “non-absorbing” or “non-absorbent” silicate mineral refers to those silicate minerals having no or lower moisture absorptive properties compared to absorbent silicate minerals (as defined herein). Silicate minerals, of course, are minerals containing some ratio of silicon and oxygen and are generally known to those of ordinary skill in the art. The compositions according to the invention can alternatively be described according to the mineral classification system according to Nickel-Strunz, a scheme for categorizing minerals based upon their chemical composition and which has been adopted by the International Mineralogical Association. Thus, the aqueous mineral slurries making up the coating compositions of the present invention can also be characterized as having a dust suppressing amount of a silicate mineral having interlocking chains of silicate tetrahedra and a Nickel-Strunz classification of 09.D. A Nickel-Strunz classification of 09; subclass D correlates to single chain and double chain inosilicates. These minerals typically have a hardness on the Mohs scale of between 4-7.

Accordingly, in certain embodiments the aqueous mineral slurry can include a dust suppressing amount of a non-absorbent silicate mineral (or silicate mineral having a Nickel-Strunz classification of 09.D) chosen from a member selected from the group consisting of Enstatite; Ferrosilite; Pigeonite; Diopside; Hedenbergite; Augite; Jadeite; Acmite; Spodumene; Wollastonite; Rhodonite; Pectolite; Anthophyllite; Cummingtonite; Grunerite; Tremolite; Actinolite; Hornblende; Glaucophane; Riebeckite; Arfvedsonite; and mixtures thereof

In certain embodiments, the aqueous mineral slurry includes a dust suppressing amount of Wollastonite.

In certain embodiments, the aqueous mineral slurry can also include a dust suppressing amount of an absorbent silicate mineral having parallel sheets of silicate tetrahedra. As used herein, the term “absorptive” or “absorbing” or “absorbent” silicate mineral refers to those silicate minerals that have greater capacity to absorb moisture or fluid relative to non-absorbent silicate minerals described above. Alternatively, the dust suppressing amount of absorbent silicate minerals can be described according to the Nickel-Strunz classification system as described above. Thus, the aqueous mineral slurry can also include (in addition to a dust suppressing amount of a silicate mineral having interlocking chains of silicate tetrahedra and a Nickel-Strunz classification of 09.D), a dust suppressing amount of a silicate mineral having parallel sheets of silicate tetrahedra and a Nickel-Strunz classification of 09.E, which correlates to phyllosilicates. Typically these minerals have a hardness on the Mohs scale of between 1-3.5.

Accordingly, in certain embodiments the aqueous mineral slurry can further include a dust suppressing amount of an absorbent silicate mineral (or silicate mineral having a Nickel-Strunz classification of 09.E) chosen from a member selected from the group consisting of Antigorite; Chrysotile; Lizardite; Halloysite; Kaolinite; Illite; Bentonite; Montmorillonite; Vermiculite; Talc; Palygorskite; Attapulgite; Sepiolite; Pyrophyllite; Biotite; Muscovite; Phlogopite; Lepidolite; Margarite; Glauconite; Chlorite; and mixtures thereof.

In some embodiments, the aqueous mineral slurry according to the invention can include Wollastonite in combination with one or more of Montmorillonite, Kaolinite, or Bentonite.

While various amounts of the silicate mineral component(s) can be present in any proportion or combination, depending on the type of substrate, the desired degree of dust abatement, etc., preferred embodiments will typically include a workable solids level of from 2% to 70% by weight of the aqueous mineral slurry. Such slurry may be adjusted or diluted as necessary for viscosity and applicability so that the final coating composition on said substrate ranges from 0.01 wt. % to 25 wt. % dry basis, based on the weight and/or type of the substrate. Where the substrate is a bulk, granular or particulate solid, for example, the final coating composition is typically from 0.01 wt. % to 7 wt. %, more typically from 0.1 wt. % to 4 wt. %, dry basis, and even more typically from 1 or 2 wt. % to 4 wt. %, dry basis. Skilled practitioners will be able to prepare and apply, a coating composition in the form of a substantially continuous outer layer and including one or more of the silicate minerals described above, which is useful in reducing or eliminating dust emission from a dust producing substrate, within the guidelines presented herein.

In some embodiments the aqueous mineral slurry can further include a dispersant chosen from a member selected from the group consisting of tetra sodium pyrophosphate; sodium polyacrylate; sodium hexametaphosphate; sodium silicate; sodium bicarbonate; and mixtures thereof. The dispersant can be present at from 0.1 wt. % to 2 wt. % based on the weight of the aqueous slurry.

In another aspect, the present invention provides a dust producing substrate coated with an aqueous mineral slurry composition as herein described. In some embodiments the dust producing substrate can include, for example, a dirt or gravel road, mine tailings, dried tailings ponds, or mineral stock piles. Treatment/application rates can be readily determined by those of skill in the art with no more than routine experimentation and consideration to factors including, for example, amount of traffic (light or heavy), size of pile, disturbance by wind/rain, density of material, attrition rate of material, etc. as discussed in U.S. Pat. No. 4,571,116. For example, in areas of high traffic or heavy wind/rain, coating compositions of aqueous mineral slurry containing higher levels of solids may be advantageously and effectively applied. Application of the coating compositions described herein can be performed by means of conventional spraying equipment with re-application performed as necessary to achieve the desired effect. Those of skill in the art will further appreciate that as regarding such large and/or expansive substrates as dirt roads or mineral stock piles, etc. the substantially continuous coating layer will be provided as a top layer (i.e., “macro-layer”), and not totally envelop the substrate as for granular or particulate substrates.

In other embodiments the dust producing substrate is a bulk, granular, particulate, or powdered solid such as, for example, a fertilizer particle, seed, or soil amendment (i.e., any additive to a soil to improve its physical and/or chemical properties), or a metal ore pellet such as iron ore. The production of such fertilizers and/or soil amendments (e.g., urea) has been well treated by the prior art and is therefore well known to those of skill in the art, and need not be described at length herein. Such particulate fertilizers include, for example, both single nutrient fertilizers (i.e., the “macronutrient” type (the so-called nitrogen, phosphorous, potassium (N,P,K) fertilizers) and the “micronutrient” type (containing elemental compounds such as Fe, Cl, Ca, Co, Cu, Zn, B, Na, Mn, Mg, Mo, S, etc.)), as well as multiple nutrient fertilizers (e.g., S—N,P,K; S-MAP; S-DAP, etc.). The nutrients can be present in any of a variety of percentages or ratios.

These fertilizer substrates can be produced by any method and can include, for example, timed/controlled release of nutrients, or presentation of nutrients as discrete platelets (i.e., thin, discontinuous nutrient fragments that are substantially planar or curved) as taught in U.S. Pat. No. 6,544,313. Other suitable fertilizer particles (and methods for producing same) for use with the present invention include those described in U.S. Pat. Nos. 7,470,304; 7,497,891; and U.S. Publication No. 2012/0285211. In certain aspects then, the present invention can be considered as an improvement over the products and processes disclosed by these references.

Accordingly, for any such fertilizer product disclosed by these references, the improvement includes a coating composition provided as a substantially continuous outer layer comprising a dust suppressing amount of an aqueous mineral slurry having at least one non-absorbent silicate mineral, and/or at least one absorbent silicate mineral. Similarly, for any such method of preparing the fertilizer product, the improvement includes coating the fertilizer product with a dust suppressing amount of an aqueous mineral slurry composition having at least one non-absorbent silicate mineral, and/or at least one absorbent silicate mineral by contacting the fertilizer product with the aqueous mineral slurry composition to form a substantially continuous outer layer, and drying the coated fertilizer product for a sufficient time and/or at a sufficient temperature to remove substantially all of the moisture therefrom, thereby coating the fertilizer composition with a substantially continuous outer layer.

In general, the methods according to the invention for coating a dust producing substrate (thereby coating the dust producing substrate and reducing or eliminating dissemination of fugitive dust particles into the atmosphere) include contacting a dust producing substrate with a coating composition of an aqueous mineral slurry containing a dust suppressing amount of a silicate mineral as described herein, and drying the coated substrate for a sufficient time and/or at a sufficient temperature to remove substantially all of the moisture from the coated substrate.

The contacting step can be performed by any suitable means known to those skilled in the art. Typically, it can be achieved by spraying on the substrate (e.g., when the substrate is a dirt road or mineral stock pile or dried tailings pond) or by mixing/tumbling with the substrate (e.g., when the substrate is in granular or particulate form).

Similarly, the drying step can also be performed by any suitable means known to those skilled in the art. In certain embodiments, the coated substrate can be heat dried as in an oven. In other embodiments, the coated substrate can be air dried and/or sun dried. The drying step is performed for a sufficient time and/or at a sufficient temperature to remove substantially all of the moisture from the coated substrate. As will be understood by those of skill in the art, “removal of substantially all of the moisture” as used herein shall mean that the majority of moisture or fluid contained in the aqueous mineral slurry is evaporated or otherwise removed so that the substrate is significantly dry to the touch, and will not agglomerate if in granular or particulate form.

In certain embodiments the coated substrate can then be screened for size and/or removal of fines.

Those skilled in the art will also appreciate that while the coating compositions described in detail herein generally take the form of, and are applied to various dust producing substrates as, an aqueous mineral slurry, the coating components included in the aqueous slurry can be shipped in dry form by any suitable means known in the art, or shipped as a liquid concentrate using any suitable aqueous diluent that is compatible with the primary aqueous media intended for use in making the mineral slurry. The dry coating components or liquid concentrate could then be diluted, or further diluted as the case may be, for immediate use at the specific site where the substrate will be coated. Such shipping methods would be advantageous in terms of cost reduction, handling, and/or storage since the volume of material actually shipped would be greatly reduced.

### Additional Embodiments (AE)

AE1.In a fertilizer composition having a plurality of particles comprising:
(a) a fertilizer portion; and
(b) a sulphur portion as a plurality of discrete platelets embedded within said fertilizer portion, or substantially covering the surface of the fertilizer portion, the improvement comprising:
   a coating composition provided as a substantially continuous outer layer, said coating composition comprising a dust suppressing amount of at least one absorbing silicate mineral as described herein; and/or at least one non-absorbent silicate mineral as described herein.

AE2. In a method for preparing a fertilizer composition comprising:
(A) applying a first plurality of particles comprising a fertilizer with (a) elemental sulphur and then (b) a slurry comprising a fertilizer or precursor thereof; and
(B) curing the product of step (A) to form a second plurality of particles comprising
   (i) a fertilizer portion and (ii) a plurality of discrete sulphur platelets embedded within said fertilizer portion, or (iii) a sulphur portion substantially covering the surface of the fertilizer particle,
the improvement comprising coating the product of step (B) with a substantially continuous outer layer by:
contacting the product of step (B) with an aqueous mineral slurry composition comprising a dust suppressing amount of at least one absorbent silicate mineral as described herein, and/or at least one non-absorbent silicate mineral as described herein to form a substantially continuous outer layer on the product of step (B); and
drying the coated fertilizer composition for a sufficient time and/or at a sufficient temperature to remove substantially all of the moisture therefrom, thereby coating the fertilizer composition with a substantially continuous outer layer.

AE3. In a method of producing a phosphate fertilizer, comprising:
producing a first portion of the phosphate fertilizer comprising adding a solid micronutrient to phosphoric acid in a heated, stirred reactor to dissolve the micronutrient and produce an enriched acid; adding the enriched acid and liquid ammonia to a pipe cross reactor; and allowing the enriched acid and the ammonia to react to produce ammonium phosphate;
producing a second portion of the phosphate fertilizer comprising combining ammonia and phosphoric acid in a pre-neutralizer to produce a second portion of the phosphate fertilizer; adding a micronutrient to the phosphoric acid before the phosphoric acid is combined with ammonia in the pre-neutralizer; and
supplying both the first and second portions of the phosphate fertilizer to a granulator to complete formation of the phosphate fertilizer,

the improvement comprising coating the phosphate fertilizer formed above with a substantially continuous outer layer by:
contacting the phosphate fertilizer formed above with an aqueous mineral slurry composition comprising a dust suppressing amount of at least one absorbent silicate mineral as described herein, and/or at least one non-absorbent silicate mineral as described herein to form a substantially continuous outer layer on the phosphate fertilizer; and
drying the coated fertilizer composition for a sufficient time and/or at a sufficient temperature to remove substantially all of the moisture therefrom, thereby coating the phosphate fertilizer with a substantially continuous outer layer.

AE4. In a method of producing a phosphate fertilizer, comprising:
producing a first portion of the phosphate in a pipe cross reactor;
producing a second portion of the phosphate in a pre-neutralizer;
supplying both the first and second portions of the phosphate to a granulator; and
adding ammonia to the granulator to react with the first and second portions of the phosphate, wherein the first and second portions of the phosphate are produced by reacting ammonia with phosphoric acid, a target ratio of ammonia to phosphoric acid achieves a desired product, ammonia and phosphoric acid are supplied to the pre-neutralizer with an ammonia deficiency and an ammonia to phosphoric acid ratio less than the target ratio, and the ammonia added to the granulator compensates for the ammonia deficiency,

the improvement comprising coating the phosphate fertilizer formed above with a substantially continuous outer layer by:
contacting the phosphate fertilizer formed above with an aqueous mineral slurry composition comprising a dust suppressing amount of at least one absorbent silicate mineral as described herein, and/or at least one non-absorbent silicate mineral as described herein to form a substantially continuous outer layer on the phosphate fertilizer; and
drying the coated fertilizer composition for a sufficient time and/or at a sufficient temperature to remove substantially all of the moisture therefrom, thereby coating the phosphate fertilizer with a substantially continuous outer layer.

AE5. In a process for the manufacture of sulphur-containing fertilizers, the process comprising the steps of: (a) bringing a liquid phase comprising elemental sulphur into contact with ammonia, phosphoric acid and water in a reactor unit to obtain an ammonium phosphate mixture, wherein the elemental sulphur is introduced into the reactor unit substantially at the same time as the other reactants; and (b) introducing the mixture obtained in step (a) into a granulator unit to obtain granules,

the improvement comprising coating the sulphur-containing fertilizer formed above with a substantially continuous outer layer by:
contacting the sulphur-containing fertilizer with an aqueous mineral slurry composition comprising a dust suppressing amount of at least one absorbent silicate mineral as described herein, and/or at least one non-absorbent silicate mineral as described herein to form a substantially continuous outer layer; and
drying the coated sulphur-containing fertilizer composition for a sufficient time and/or at a sufficient temperature to remove substantially all of the moisture therefrom, thereby coating the sulphur-containing fertilizer with a substantially continuous outer layer.

AE6. In a fertilizer composition for forming a plurality of particles having enhanced particle integrity, the fertilizer composition comprising:
a phosphate fertilizer portion;
at least one of a micronutrient or a secondary nutrient; and
a fibrous material,

the improvement comprising:
a coating composition provided as a substantially continuous outer layer, said coating composition comprising a dust suppressing amount of at least one absorbing silicate mineral as described herein; and/or at least one non-absorbent silicate mineral as described herein.

AE7. In a method of producing phosphate fertilizer granules including fibrous material to enhance particle integrity, the method comprising:
preparing a pre-neutralized slurry including ammonium sulphate, phosphoric acid, and fibrous material;
charging the pre-neutralized slurry with ammonia until a partially ammoniated solution is produced;
supplying the partially ammoniated solution to a granulator; and
adding ammonia to the granulator to complete formation of the phosphate fertilizer granules including fibrous materials,
the improvement comprising:
coating the phosphate fertilizer granules formed above with a substantially continuous outer layer by:
   contacting the phosphate fertilizer with an aqueous mineral slurry composition comprising a dust suppressing amount of at least one absorbent silicate mineral as described herein, and/or at least one non-absorbent silicate mineral as described herein to form a substantially continuous outer layer; and
   drying the coated phosphate fertilizer composition for a sufficient time and/or at a sufficient temperature to remove substantially all of the moisture therefrom, thereby coating the phosphate fertilizer with a substantially continuous outer layer.

AE8. The improvement according to any one of AEs 1-7, wherein the absorbent silicate mineral has a Nickel-Strunz classification of 09.E and the non-absorbent silicate mineral has a Nickel Strunz classification of 09.D.

AE9. The improvement according to any one of AEs 1-8, wherein
the absorbent silicate mineral is chosen from a member selected from the group consisting of Antigorite; Chrysotile; Lizardite; Halloysite; Kaolinite; Illite; Bentonite; Montmorillonite; Vermiculite; Talc; Palygorskite; Attapulgite; Sepiolite; Pyrophyllite; Biotite; Muscovite; Phlogopite; Lepidolite; Margarite; Glauconite; Chlorite; and mixtures thereof; and
the non-absorbent silicate mineral is chosen from Enstatite; Ferrosilite; Pigeonite; Diopside; Hedenbergite; Augite; Jadeite; Acmite; Spodumene; Wollastonite; Rhodonite; Pectolite; Anthophyllite; Cummingtonite; Grunerite; Tremolite; Actinolite; Hornblende; Glaucophane; Riebeckite; Arfvedsonite; and mixtures thereof.

AE10. The improvement according to any one of AEs 1-9, wherein the non-absorbent silicate mineral is Wollastonite and the absorbent silicate mineral is chosen from a member selected from the group consisting of Montmorillonite; Kaolinite; Bentonite; and mixtures thereof.

AE11. The improvement according to any one of AEs 1-10, wherein the silicate mineral components are present in the aqueous mineral slurry in any proportion or combination thereof at a workable solids level of from 2% to 70% by weight of the slurry.

AE12. The improvement according to AE 11, wherein the aqueous mineral slurry further comprises a dispersant chosen from a member selected from the group consisting of tetra sodium pyrophosphate; sodium polyacrylate; sodium hexametaphosphate; sodium silicate; sodium bicarbonate; and mixtures thereof.

AE13. The improvement according to any one of AEs 1-12, wherein the coating composition or layer is from 0.01 wt. % to 7 wt. % of the fertilizer particle on a dry basis.

AE14. The improvement according to AE 13, wherein the coating composition or layer is from 0.1 wt. % to 5 wt. % of the fertilizer particle on a dry basis.

AE15. The improvement according to AE 14, wherein the coating composition is from 2 wt. % to 4 wt. % of the fertilizer particle on a dry basis.

### EXAMPLES

The following examples are provided to assist one skilled in the art to further understand certain embodiments of the present invention. These examples are intended for illustration purposes and are not to be construed as limiting the scope of the present invention.

### Example 1

### Preparation of Coating Compositions

Samples 1-3—719.2 grams of tap water is poured into a WARING® blender jar.
To the water, 0.8 grams of polyacrylate dispersant (such as KemEcal™211, available from Kemira Oyj, Atlanta, Ga.) is added and mixed at the #1 setting for 30 seconds. Then, 56 grams of Na-Montmorillonite (such as NATIONAL® Premium 325 WT available from Halliburton, Houston, Tex.) or kaolin (generally available) as appropriate is added, followed by 24 grams of Wollastonite (such as NYGLOS® 4W available from NYCO Minerals, Willsboro, N.Y.) or Attapulgite (such as L 11-605 available from Oil-Dri Corp., Chicago, Ill.). The resultant slurry is mixed at #4 setting of the WARING® blender for 5 minutes. Finally, pH is recorded for the slurry.

Samples 4-5—are prepared as above for Samples 1-3, except that 80 grams of Na-Montmorillonite, or Wollastonite are added, as appropriate.

Sample 6—is prepared as above for Samples 1-3, except using 2697 grams of tap water, 3.0 grams of polyacrylate dispersant, and 300 grams of Attapulgite.

Table 1 illustrates the formulation of the coating compositions described for Samples 1-6.

TABLE 1

| | Mineral/Material | S-1 | S-2 | S-3 | S-4 | S-5 | S-6 |
|---|---|---|---|---|---|---|---|
| Component 1 | Wollastonite | 24 | | 24 | | 80 | |
| Component 2 | Attapulgite | | 24 | | | | 300 |
| Component 3 | Montmorillonite | 56 | 56 | | 80 | | |
| Component 4 | Kaolin | | | 56 | | | |
| Dispersant | polyacrylate | 0.8 | 0.8 | 0.8 | 0.8 | 0.8 | 3.0 |
| Water | | 719.2 | 719.2 | 719.2 | 719.2 | 719.2 | 2697 |
| total weight | grams | 800.0 | 800.0 | 800.0 | 800.0 | 800.0 | 3000.0 |
| Slurry pH | | 10.0 | 10.0 | 10.0 | 10.0 | 10.0 | 7.5 |

### Example 2

### Coating of Fertilizer Substrate

For each coating composition above (Samples 1-6), a 1.5 Kg sample of commercially available sulphur-containing fertilizer substrate (e.g., MICROESSENTIALS® SZ available from The Mosaic Company, Plymouth, Minn.) is heated to 100° C. for one hour and transferred to a particulate mixer (Dayton Model 3K771K). The coating composition is added as appropriate (0-4 wt. %, dry basis) over a 2 minute period while the mixer is rotating at 44 RPM. After the addition of coating composition is complete, the coated fertilizer is tumbled in the rotating mixer for 10 additional minutes to achieve an outer layer of a substantially continuous, uniform coating on the particulate surfaces. The coated fertilizer substrate is then moved to an oven set at 100° C. for 1.5-3 hrs. for removal of substantially all of the moisture. Finally, the coated fertilizer substrate is stored at 60° C. under 30-50% humidity overnight and then stored at ambient conditions for 25 days, following which time the coated fertilizer substrates are evaluated for dust emission. Samples coated for evaluation are shown below in Table 2.

TABLE 2

| | Coating levels (Wt. %), |
|---|---|
| Coating composition | dry basis |
| S-1 | 2% |
| S-1 | 4% |
| S-2 | 2% |
| S-3 | 2% |
| S-3 | 4% |
| S-4 | 2% |
| S-5 | 2% |
| S-6 | 2% |
| Control | No coating |

### Example 3

### Dust Emission Measurement

Dust measurements are conducted using a Heubach brand dustmeter (HeubachColor, Germany) at type I setting. For each coated fertilizer substrate made above, 100 grams sample is weighed and placed into the rotating drum of the Heubach dustmeter. The dustmeter is set at 50 rotations per minute, to an air flow of 20 liters/minute, and the duration of rotation is 300 seconds. The measurements are performed at ambient temperature and at 40-60% relative humidity. If the machine display indicates that rotational velocity or the air throughput is not maintained throughout within ±10%, then the measurement is repeated with a new sample.

A glass fibre filter (Whatman GF92 or equivalent) is used in the filter assembly of the Heubach dustmeter. The filter paper is weighed before mounting in the assembly with a precision of 0.1 mg. The dust value is calculated simply by subtracting the weight of the filter paper before and then after the test.

The dust measurement is repeated twice with each sample, with fresh sample from the 1.5 Kg batch loaded in between runs. If the results deviate more than 20%, then additional tests are run. Between each test, the Heubach appliance is thoroughly cleaned with intense vacuum. The contaminated filter is removed and saved for further analysis. The mean value of the test results are reported in Table 3 below.

TABLE 3
Dust generated using various coating compositions

| | Coating levels | | % Reduction |
|---|---|---|---|
| Coating | (Wt. %), | | compared to |
| composition | dry basis | Dust (ppm) | control |
| S-1 | 2% | 81.5 | 67 |
| S-1 | 4% | 31 | 87 |
| S-2 | 2% | 109 | 56 |
| S-3 | 2% | 39 | 84 |
| S-3 | 4% | 36.5 | 85 |
| S-4 | 2% | 116 | 53 |
| S-5 | 2% | 46 | 81 |
| S-6 | 2% | 64.5 | 74 |
| Control | No coating | 246 | |

The results show that all the coating compositions containing aqueous mineral slurry according to the invention reduced dust emissions of the fertilizer substrate by about 50% to about 87% compared to the control.

### Example 4

### Surface Analysis

The fertilizer surface composition and coating continuity can be quantified by surface analysis of the coated and uncoated sulphur-containing fertilizer particles. A higher Phosphorous/Sulphur ratio is a typical indication of the existence of coating on the fertilizer particle. The continuity of the coating can be analyzed both by elemental mapping and by increasing P/S ratio. All samples can be viewed using a Zeiss Sigma VP SEM/EDX equipped with a Bruker EDX detector. Spectra and maps can be acquired at 30 KeV so that the electron beam does not damage the S and P atoms on the fertilizer particle surface. Images can be acquired using a SE detector and/or a backscatter detector.

As employed above and throughout the disclosure, various terms are provided to assist the reader. Unless otherwise defined, all terms of art, notations and other scientific terminology used herein are intended to have the meanings commonly understood by those of skill in the mineral and/or mining chemical arts. As used herein and in the appended claims, the singular forms include plural referents unless the context clearly dictates otherwise. All numbers expressing quantities of ingredients, reaction conditions, and so forth used in the specification and claims are to be understood as being modified in all instances by the term “about.” Similarly, all numbers expressed in a range as indicated by the word “between” include the upper and lower limits in the range. Accordingly, unless indicated to the contrary, the numerical parameters set forth in the specification and attached claims are approximations that may vary depending upon the desired properties sought to be obtained by the present invention. At the very least, and not as an attempt to limit the application of the doctrine of equivalents to the scope of the claims, each numerical parameter should be construed in light of the number of significant digits and ordinary rounding approaches.

Various patent and/or scientific literature references have been referred to throughout this application. The disclosures of these publications in their entireties are hereby incorporated by reference as if written herein. In the case of conflicting terms, the terms of this document will take preference. In view of the above description and the examples, one of ordinary skill in the art will be able to practice the invention as claimed without undue experimentation.

Although the foregoing description has shown, described, and pointed out the fundamental novel features of the present invention, it will be understood that various omissions, substitutions, and changes in the form of compositions, as well as the uses thereof, may be made by those skilled in the art, without departing from the scope of the present teachings. Consequently, the scope of the present invention should not be limited to the foregoing discussion, but should be defined by the appended claims.

What is claimed is:

1. A composition for reducing or eliminating dissemination of fugitive dust particles into the atmosphere from a dust producing substrate, the composition comprising:
an aqueous mineral slurry comprising a dust suppressing amount of a non-absorbent silicate mineral having interlocking chains of silicate tetrahedra.

2. A composition according to claim 1, wherein the non-absorbent silicate mineral has a Nickel-Strunz classification of 09.D.

3. A composition according to claim 1, wherein the non-absorbent silicate mineral is chosen from a member selected from the group consisting of single chain inosilicates; double chain inosilicates; and mixtures thereof.

4. A composition according to claim 3, wherein the single chain inosilicate is chosen from a member selected from the group consisting of Enstatite; Ferrosilite; Pigeonite; Diopside; Hedenbergite; Augite; Jadeite; Acmite; Spodumene; Wollastonite; Rhodonite; Pectolite; and mixtures thereof

5. A composition according to claim 3, wherein the double chain inosilicate is chosen from a member selected from the group consisting of Anthophyllite; Cummingtonite; Grunerite; Tremolite; Actinolite; Hornblende; Glaucophane; Riebeckite; Arfvedsonite; and mixtures thereof

6. A composition according to claim 3, wherein the non-absorbent silicate mineral is Wollastonite.

7. A composition according to claim 1 further comprising a dust suppressing amount of an absorbent silicate mineral having parallel sheets of silicate tetrahedra.

8. A composition according to claim 7, wherein the absorbent silicate mineral has a Nickel-Strunz classification of 09.E.

9. A composition according to claim 7, wherein the absorbent silicate mineral is chosen from a member selected from the group consisting of Antigorite; Chrysotile; Lizardite; Halloysite; Kaolinite; Illite; Bentonite; Montmorillonite; Vermiculite; Talc; Palygorskite; Attapulgite; Sepiolite; Pyrophyllite; Biotite; Muscovite; Phlogopite; Lepidolite; Margarite; Glauconite; Chlorite; and mixtures thereof.

10. A composition according to claim 7, wherein the non-absorbent silicate mineral is Wollastonite and the absorbent silicate mineral is chosen from a member selected from the group consisting of Montmorillonite; Kaolinite; Bentonite; and mixtures thereof

11. A composition according to claim 7, wherein the silicate mineral components are present in any proportion or combination thereof at a workable solids level of from 2% to 70% by weight of the slurry.

12. A composition according to claim 7 further comprising a dispersant chosen from a member selected from the group consisting of tetra sodium pyrophosphate; sodium polyacrylate; sodium hexametaphosphate; sodium silicate; sodium bicarbonate; and mixtures thereof

13. A dust producing substrate coated with a substantially continuous outer layer comprising a dust suppressing amount of a composition as defined by claim 7.

14. A substrate according to claim 13, wherein said substrate is chosen from a member selected from the group consisting of single nutrient fertilizers; multiple nutrient fertilizers; soil amendments; seed; and iron ore pellets.

15. A substrate according to claim 14, wherein the substrate is single nutrient fertilizer particles and/or multiple nutrient fertilizer particles.

16. A substrate according to claim 14, wherein the dust producing substrate is seed.

17. A substrate according to claim 13, wherein said substrate is chosen from a member selected from the group consisting of a dirt road; a gravel road; mine tailings; dried tailings pond; and mineral stock piles.

18. A substrate according to claim 13, wherein the coating composition is from 0.01 wt. % to 25 wt. % of the substrate on a dry basis.

19. A substrate according to claim 18, wherein the coating composition is from 0.1 wt. % to 5 wt. % of the substrate on a dry basis.

20. A substrate according to claim 19, wherein the coating composition is from 2 wt. % to 4 wt. % of the substrate on a dry basis.

21. A method of coating a dust producing substrate with a substantially continuous outer layer, the method comprising:
contacting the slurry coating composition as defined by claim 1 with a dust producing substrate; and
drying the coated substrate for a sufficient time and/or at a sufficient temperature to remove substantially all of the moisture from the coated substrate, thereby coating the substrate with a substantially continuous outer layer.

22. A method according to claim 21, wherein the contacting step is performed by spraying or tumbling.

23. A method according to claim 21, wherein the coating composition is as defined in claim 7.

24. A method according to claim 21, wherein the coating composition is from 0.01 wt. % to 7 wt. % of the substrate on a dry basis.

25. A method according to claim 24, wherein the coating composition is from 0.1 wt. % to 5 wt. % of the substrate on a dry basis.

26. A method according to claim 25, wherein the coating is from 2 wt. % to 4 wt. % of the substrate on a dry basis.

27. A method according to claim 21, wherein said substrate is chosen from a member selected from the group consisting of single nutrient fertilizers; multiple nutrient fertilizers; soil amendments; and iron ore pellets.

28. A method according to claim 27, wherein the substrate is single nutrient fertilizer particles and/or multiple nutrient fertilizer particles.

29. A method for reducing or eliminating dissemination of fugitive dust particles into the atmosphere from a dust producing substrate, the method comprising:
coating a dust producing substrate with a dust suppressing amount of a coating composition as defined by claim 7.
